(19) United States
(12) Patent Application Publication
(10) Pub. No.: US 2013/0266501 A1
(43) Pub. Date: Oct. 10, 2013

(54) Direct Production of Large and Highly Conductive Low-Oxygen Graphene Sheets and Monodispersed Low-Oxygen Graphene Nanosheets

(71) Applicants: Huixin He, Westfield, NJ (US); Pui Lam Chiu, Fort Lee, NJ (US); Daniel Dino Thayer Mastrogiovanni, New Brunswick, NJ (US); Eric Garfunkel, East Brunswick, NJ (US)

(72) Inventors: Huixin He, Westfield, NJ (US); Pui Lam Chiu, Fort Lee, NJ (US); Daniel Dino Thayer Mastrogiovanni, New Brunswick, NJ (US); Eric Garfunkel, East Brunswick, NJ (US)

(73) Assignee: Rutgers, The State University of New Jersey, New Brunswick, NJ (US)

(21) Appl. No.: 13/776,366

(22) Filed: Feb. 25, 2013

Related U.S. Application Data
(63) Continuation of application No. 13/542,660, filed on Jul. 5, 2012, now abandoned.
(60) Provisional application No. 61/504,495, filed on Jul. 5, 2011.

(51) Int. Cl. C01B 31/04; C01B 31/00

(52) U.S. Cl. CPC C01B 31/043; C01B 31/00; Y10S 977/734; Y10S 977/847; Y10S 977/932; B82Y 40/00
USPC 423/415.1; 423/448; 977/734; 977/847; 977/932

(57) ABSTRACT

Method for making graphene sheets exfoliated by oxidation from graphite by mixing graphite powder with a solution of concentrated sulfuric acid and nitric acid and subjecting the resultant mixture to microware irradiation until a finely dispersed suspension graphene sheets is formed in the solution. Graphene sheets exfoliated by oxidation from graphite are also disclosed.

### CROSS-REFERENCE TO RELATED APPLICATIONS

This application claims priority under 35 U.S.C. §119(e) to U.S. Provisional Application Ser. No. 61/504,495 filed Jul. 5, 2011, the disclosure of which is incorporated herein by reference in its entirety.

### STATEMENT REGARDING FEDERALLY FUNDED RESEARCH

This invention was made with government support under Grant No. CHE-750201 awarded by the National Science Foundation. Accordingly, the U.S. Government has certain rights in this invention.

### BACKGROUND OF THE INVENTION

Graphene is a flat monolayer of carbon atoms tightly packed into a two-dimensional (2D) honeycomb lattice, and is a basic building block for graphitic materials of all other dimensionalities. It can be wrapped up into 0D fullerenes, rolled into 1D nanotubes or stacked into 3D graphite. Due to its excellent electronic, thermal and mechanical properties, and its large surface area and low mass, graphene holds great potential for a range of applications. Except for ultrahigh speed electronics, most of the proposed applications require large quantities of high-quality, low cost graphene (preferably solution-processable) for practical industrial scale applications. Examples include energy and hydrogen storage devices, inexpensive flexible macroelectronic devices, and mechanically reinforced conductive coatings including films for electromagnetic interference (EMI) shielding in aerospace applications.

While extensive efforts have focused on enabling cost effective mass production of solution-processable graphene sheets, most approaches known in the art rely upon Hummer's or modified Hummer's methods. These methods involve tedious and time consuming procedures. In brief, one most first oxidize graphite powder, exfoliate the oxidized product to form nonconductive graphene oxide (“GO”) suspensions, and finally a reducation procedure to recover some fraction of its electrical conductivity.

In addition, the processes that rely upon Hummer's or modified Hummer's methods cause uncontrollably cutting of the graphene sheets into small pieces, and formation of a large amount of nanometer sized holes and vacancies in their basal planes. These holes and vacancies decrease the integrity of the material thus significantly altering their desired physical properties, such as molecular impermeability, electrical and thermal conductivity, and mechanical strength.

Furthermore, during the reduction step, in order to prevent aggregation of individual graphene sheets, surfactants and/or stabilizers are added which results in graphene with species attached to both sides. If remained in a deposited thin film, these stabilizers could introduce a large contact resistance between sheets; therefore, dramatically decreasing the overall electrical conductivity.

In addition, even though new environmentally friendly reduction protocols are being developed, hydrazine, a highly hazardous material, is still widely used as the reduction agent to restore the conductivity of graphene. Finally, trace amounts of reduction chemicals and metal ions following the Hummer's approaches can participate in unwanted reactions and be detrimental to applications such as organic solar cells. Therefore, extensive cleaning and purification steps are required, which makes industrial scale production expensive.

Moreover, due to its high near infrared (NIR) absorption, photothermal conversion efficiency, and exceptionally large surface area, graphene has attracted interest for biomedical applications, particularly in developing multifunctional drug delivery systems. While single layered graphene sheets with large lateral sizes and limited surface functionalization are required for use in many electronic and optical devices, applications of graphene in biomedical applications, such as drug delivery and photothermal and photodynamic therapies, require monodispersed graphene sheets with lateral dimensions on the order of nanometers (typically <50 nm).

While some efforts have been made to fabricate graphene sheets with controlled sizes and structures for drug delivery, the dominant approaches typically rely upon Hummer's or modified Hummer's methods. In addition to the above-mentioned drawbacks, the as-synthesized sheets are usually poly-disperse, ranging from a few nanometers to tens of micrometers. To reach a predefined nanometer-sized GO sheet, oxidation and sonication time are optimized. The final GO products still have a large distribution of size and shape. To increase the size uniformity of the GO sheets, extensive size separation steps need to be performed. Furthermore, compared to graphene, GO has a very low absorption capability in the near infrared (NIR) region, chemical, reduction is required to recover some fraction of its NIR absorption and photothermal conversion efficiency for its applications in multifunctional photothermal and/or photodynamic therapies.

Recently, monodispersed reduced GO (rGO) nanosheets have been directly produced through hydrothermal and electrochemical processes. Depending on their molecular structures, these rGO graphene nanosheets show blue, green, or yellow luminescence, which are useful for bio-imaging applications. However, the photothermal conversion efficiency may be low due to strong light emission. Furthermore, all these fabrication methods are based on starting materials such as from GO or reduced GO, which is typically synthesized from Hummer's or modified Hummers' methods.

On the other hand, size-controlled synthesis of GO or rGO via facile one-step wet chemistry have been reported using starting materials which are already small. For example, graphene oxide nanocolloids and reduced graphene nanosheets can be made from graphite nanofibers or carbon fibers. However, these starting materials are much more expensive than graphite particles. There is no study that has been reported to directly produce monodispersed graphene nanosheets with low oxygen functionalization, and therefore with high NIR absorption and photothermal conversion efficiency.

### SUMMARY OF THE INVENTION

The need for a process that avoids the aforementioned pitfalls is met by the present invention. Accordingly, the present invention includes highly conductive amphophilic graphene sheets, which can be directly and rapidly fabricated from cheap and abundant graphite particles without post reduction processing, and can be dispersed in aqueous or organic solvents without stabilizers. Also, the present invention includes monodispersed graphene nanosheets, that are directly and rapidly fabricated from cheap and abundant graphite particles without post-separation and reduction processes, and also can be dispersed in aqueous or organic solvents without stabilizers.

Thus, in accordance with the present invention, there is provided simple and scalable methods for quickly and directly producing highly conductive low-oxygen graphene sheets and monodispersed low-oxygen graphene nanosheets. These methods include the microwave irradiation of graphite powder in a mixture of sulfuric acid and nitric acid.

Specifically, one embodiment of this invention includes a method for making Microwave Enabled Low Oxygen Graphene Sheets (“ME-LOGr”), which includes mixing graphite powder with a solution of concentrated sulfuric acid and nitric acid; and subjecting the resultant mixture to microware irradiation until a finely dispersed suspension of ME-LOGr sheets is formed in said solution.

Another embodiment of this invention further includes the step of dialyzing the suspension, resulting in a colloidal ME-LOGr solution.

Another embodiment of this invention further includes the step of vacuum filtrating said solution through an anodic filter membrane.

In another embodiment of this invention, the weight mole ratio of graphite (gram) and nitronium ions (mole), which are produced by mixing sulfuric acid and nitric acid, is between 50 to 0.5 (g/mole) ratio, preferably between 50 g/mole to 30 g/mole for large graphemes and 0.5 to 10 g/mole for nanographene sheets. The ratio of sulfuric acid to nitric acid and total quantity of the two acids relative to the graphite that produces the moles of nitronium ion relative to the quantity of graphite is readily determined by one of ordinary skill in the art without undue experimentation.

One embodiment of this invention includes a ME-LOGr product produced according to the method previously discussed.

Another embodiment of this invention includes a graphene sheets exfoliated by oxidation from graphite with an average lateral size between about 1 micrometer to about 100 micrometers.

Another embodiment of this invention includes a graphene nanosheets exfoliated by oxidation from graphite with an average lateral size between about 3 nanometers to about 100 nanometers.

In another embodiment of this invention includes graphene sheets exfoliated from graphite with a carbon-to-oxygen ratio between about 10:1 and about 50:1.

Yet another embodiment of this invention includes graphene sheets exfoliated from graphite with a conductivity as-synthesized between about 2000 s.m⁻¹ and about 10,000 s.m⁻¹. Reduction provides graphene with a conductivity in the range of 12,000 s.m⁻¹ to 200,000 s.m⁻¹.

### BRIEF DESCRIPTION OF THE DRAWINGS

FIG. 1: (a) Schematic drawing showing the proposed oxidation mechanism to directly produce highly conductive, low-oxygen containing amphophilic graphene sheets. A nitronium ion forms a single electron transfer (SET) intermediate with a graphene layer, which is intercepted by a rapid oxygen transfer from molecular oxygen, affording an epoxy group, or from NO²⁺ to form an OH group. (b) Atomic force microscopy (AFM) image of a large ME-LOGr sheet deposited on a freshly cleaved mica surface. (c) UV-vis spectra of ME-LOGr (red) and GO (black). Inset: digital photograph showing the different colorations of ME-LOGr and GO solutions in water.

FIG. 2: Raman spectra of ME-LOGr (red) and GO (black). The small intensity ratio of D/G bands and the high intensity of the 2D band in ME-LOGr are in contrast to the larger D/G baud ratio and the absence of a 2D band in GO, indicating ME-LOGr has more ideal graphitic structures without adsorbent-induced surface modification.

FIG. 3. (a) Representative high resolution transmission electron microscope (HRTEM) image of ME-LOGr, which is composed of many different crystalline-like domains with average lateral size of 6-10 nm. No nanometer-sized holes are observed which is highly in contrast to GO and rGO. The size of the crystalline domains is also much larger than those observed in GO and rGO. (b) Fast Fourier transform (FFT) pattern of the selected region indicated in (a). (c) The reconstructed image of the same spot as (b) after filtering with the frequency domain to include contributions from both sets of hexagons of the FFT pattern. The scale bar in (a) is 5 nm.

FIG. 4: Carbon 1s core X-ray photoelectron spectroscopy (XPS) spectra for thin films of (a) ME-LOGr and (b) GO. The content of oxygen-free carbon of ME-LOGr was 79%, which was comparable with the reported value of fully reduced GO, while GO (b) contains only 49% of oxygen-free carbon. This is direct evidence of much less oxidation in the ME-LOGr.

FIG. 5: (a) Thermogravimetric Analysis (TGA) curves of % weight loss plotted against temperature showing that ME-LOGr (red) is thermally ranch more stable than GO (blue) and highly comparable with its parent graphite (black). (b) Percolation study of ME-LOGr and GO using a four-point probe setup. After percolation threshold, the sheet resistivity of ME-LOGr (red) is 5 orders of magnitude lower than that of the heavily oxidized GO films.

FIG. 6: a) Field emission scanning electron microscope (FE-SEM) image of a large graphene sheet deposited onto a SiO₂/Si substrate. b) Scanning transmission electron microscope (STEM) image of a graphene sheet deposited onto a holey carbon film on Cu from the same graphene dispersion. c) A magnified image of the circled area in figure SIb showing a side of a large graphene sheet.

FIG. 7: Digital photographs of stable ME-LOGr solution in water and in DMF. The clear Tyndall effect from both solutions indicated the colloidal characteristic of these solutions. FIG. 7a, ME-LOGr aqueous solution. FIG. 7b and 7c is ME-LOGr in DMF.

FIG. 8: Representative AFM images of ME-LOGr and GO. (a) ME-LOGr via bath sonication; (b) graphene oxide prepared by Hummers' method; (c) ME-LOGr prepared by magnetic stirring. The arrows in figure (b) indicate foldings and wrinkles. The height profiles are shown in red lines in each image.

FIG. 9: A UV-Vis spectrum and digital photograph of the graphene solution obtained by adding a small amount of KMnO₄ in the mixture of H₂SO₄/HNO₃. The λmax at 245 nm indicates that this material is heavily oxidized during the 30 seconds of microwave irradiation. The brownish yellow color indicates a high-degree of functionalization of the graphene surface.

FIG. 10: Attenuated total reflectance Fourier transformed infrared (ATR-FTIR)spectra of ME-LOGr (red) and GO (black) showing that small amount of epoxy and hydroxyl groups in ME-LOGr, while GO is heavily decorated with a variety of oxygen-containing groups.

FIG. 11: AFM images of ME-LOGr nanosheets, which are directly obtained with (a) two-minute microwave irradiation and (b) a 30 second irradiation with a higher nitronium ion concentration.

FIG. 12: A XPS of ME-LOGr nanosheets, which are fabricated with a 30 second microwave irradiation and a higher nitronium ion concentration.

FIG. 13: UV-Vis spectra of ME-LOGr nanosheets (blue), large sheets (red) and GO (black). Compared to GO, the graphene sheets show strong visible and NIR absorption almost independent of their size.

### DETAILED DESCRIPTION OF THE INVENTION

The disclosed invention provides highly conductive amphophilic graphene sheets which can be dispersed in aqueous or organic solvents without stabilizers and/or a reduction process, monodisperse low-oxygen containing graphene nanosheets, and simple and scalable methods for quickly and directly producing said highly conductive amphiphilic graphene sheets and said monodisperse low-oxygen containing graphene nanosheets.

### Large Microwave Enabled Low-Oxygen Containing Grapheme Sheets

The simple and scalable method for producing highly conductive amphophilic graphene sheets includes the microware irradiation of graphite powder in a mixture of sulfuric acid and nitric acid. Compared to those reduced graphene sheets prepared by the commonly used Hummer's method, the graphene sheets of the instant invention have much larger sizes with fewer defects, better thermal stability and comparable or higher conductivity to those reported solution processable graphene sheets.

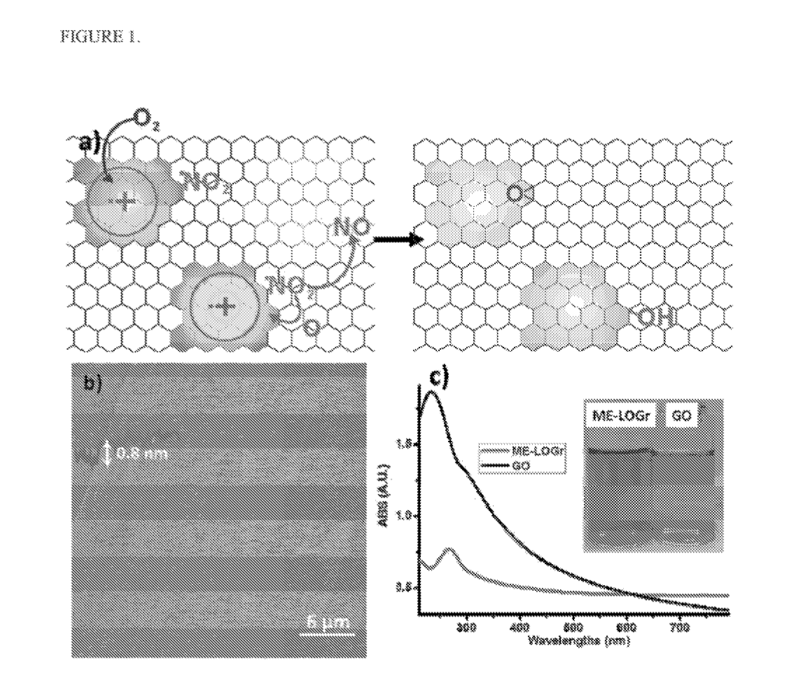

To create the graphene sheets, the oxidation mechanism of nitronium ion (“NO₂”) produced by mixing concentrated sulfuric acid (“H₂SO₄”) and nitric acid (“HNO₃”), is used. Nitronium ions interact with a graphene surface to form multiple aromatic radical-ion pairs via a single electron transfer (“SET”) pathway. At higher temperatures, multiple hydroxyl (“—OH”) and/or epoxy groups are formed across the surface following oxygen transfer processes to the aromatic radicals, as shown in FIG. 1a. Due to the electron donating capability of the resulting —OH and epoxy groups, subsequent oxidation results in more —OH and epoxy groups that are preferentially formed far away from the already oxidized carbon atoms. This is in contrast to potassium permanganate (“KMnO₄”), which preferentially attacks adjacent carbon atoms. An important consequence is that the initial oxidation by NO₂⁺ can naturally produce intact graphene domains separated by regions of oxygen-containing groups.

The amount of sulfuric acid and nitric acid mixed together is selected to provide a weight:mole ratio of graphite (gram) and nitronium ions (mole) effective to produce graphene domains. The g/mole ratio of graphite to nitronium ions should range between about 100 to about 0.3 g/mole ratio, and more typically between about 50 to about 0.5 g/mole. The relative amounts of sulfuric acid and nitric acid that should be mixed together for a given quantity of graphite to achieve the desired g/mole ratio of graphic and nitronium ions can be readily determined by one of ordinary skill in the art without undue experimentation. To achieve larger size graphene sheets, a weight ratio between about 50 g/mole to about 30 g/mole should be used, and more typically between about 45 and about 35 g/mole. For nanographene sheets, between about 0.5 to about 25 g/mole should be used, and more typically between about 0.8 and about 10 g/mole.

If the reaction does not stop in a timely manner, subsequent oxidation will lead to the formation of oxides, vacancies, larger holes, and ultimately cutting of the graphene into small pieces, analogous to what was shown in previous carbon nanotube (CNT) cutting studies. Therefore, the key to directly produce large, conductive graphene sheets by NO₂⁺ is to quickly produce the low concentration of oxygen moieties that is required for the separation of individual graphene sheets, and then quench the reaction before holes and/or vacancies form.

To satisfy this requirement, microwave heating is exploited. Specifically, the process used in accordance with the present invention uniformly heats a sample of graphite powder, sulfuric acid and nitric acid by irradiating the sample with electromagnetic radiation in the microwave or radio frequency range. The microwave heating produced by the electromagnetic radiation allows for extremely fine control of the molecular alignment, and thus the free volume, of the resulting graphene sheets.

The frequency of the electromagnetic radiation used in the microwave or radio frequencies ranges from 10⁸ to 10¹¹ Hertz )“Hz”). The electromagnetic radiation may be pulsed or continuous. The input power is selected to provide the desired heating rate. In one embodiment, the output power is up to about 1-2 kilowatts.

When using pulsed radiation, any arrangement of poise duration and pulse repetition frequency which allows for the dissipation of adverse heat buildup may be used in the present invention. The pulse duration may be varied, from 1 to 100 microseconds and the pulse repetition frequency from 2 to 1000 pulses per second. The sample may be irradiated for any period of time sufficient to form the graphene sheets and can be readily determined by one of ordinary skill in the art without undue experimentation. The time required to achieve the result will be shorter for higher power settings.

When continuous radiation is utilized, the sample is heated for a time sufficient to form the graphene sheets. As with pulsed radiation, the time, frequency and power input can be routinely adjusted to achieve the desired result, which can be readily determined by one of ordinary skill in the art without undue experimentation.

Typically, continuous radiation is first employed to attain the desired reaction temperature, after which, pulsed radiation is employed to maintain the desired temperature. Accordingly, the duration of continuous radiation, pulse radiation duration, and radiation frequency can be readily adjusted by one having ordinary skill in the art to achieve the desired result based on simple calibration experiments. The extent of graphene formation may he confirmed, by conventional analytical techniques.

Irradiation of the sample may be conducted in any microwave and/or radio frequency heating device which is capable of continuous or pulsed radiation and has the power requirements necessary to thermally induce the conversion to graphene. Suitable heating devices include microwave ovens, wave guides, resonant cavities, and the like. Suitable heating devices are well known in the art and commercially available.

The preferred device for performance of the present invention is a single-mode resonant cavity. Any available mode for heating in this device can be used in the present invention. However, the present invention is not to be limited to use of this device but can be performed in any microwave or radio frequency heating equipment.

In general, the process of the present invention is carried out by placing the sample inside of a microwave or radio frequency device and applying the appropriate input power. The present invention may be applied as either a batch or continuous process.

Due to the high conductivity and polarizability of graphene (and graphite), the local temperature can be significantly increased (under microwave irradiation), which in turn leads to higher oxidation rates. Furthermore, movement of the intercalation agent, H₂SO₄, and the oxidant, NO₂⁺, is also dramatically increased upon microwave irradiation due to their ionic nature. These concerted processes lead to the rapid dispersion of large graphene sheets containing a minimal amount of oxygen. Due to the essential role of microwave heating during the production, we refer to these graphene sheets as microwave-enabled low-oxygen graphene (ME-LOGr).

Thus, to create large graphene sheets, the composition of graphite powder, sulfuric acid and nitric acid is heated using microware irradiation tor generally between 10 and 60 seconds, or longer.

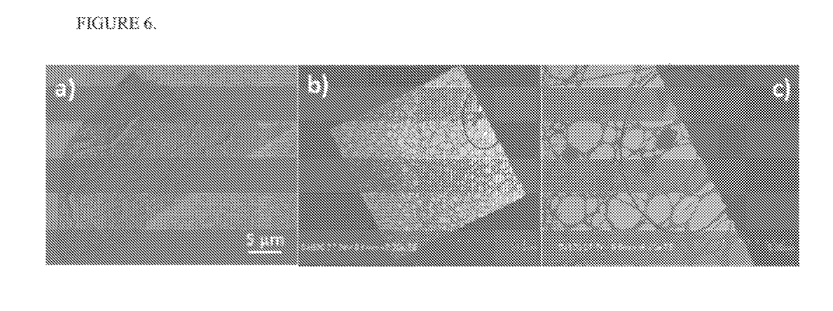

The reaction results in a finely dispersed suspension that is easier to purify and handle than the sticky paste obtained from Hummer's method. A colloidal graphene solution is obtained through direct dialysis this suspension. Atomic force microscopy (AFM), scanning electron microscopy (SEM), and scanning transmission electron microscopy (STEM) (FIG. 6) reveal that the lateral size of the single graphene sheets that are in the range of 1 to 100 μm. An average size between about 2 to 30 μm is more typical. More typically, the sheet size is essentially the size of the starting graphite powder, suggesting that no cutting occurs during the short microwave irradiation.

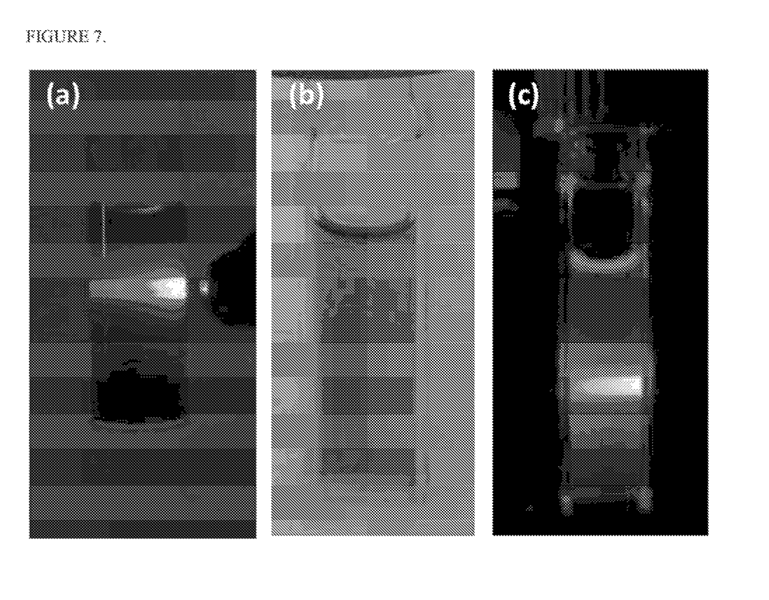

Graphene powder can be collected by filtration, which can be re-dispersed in water to form colloidal solutions (at concentrations of up to 3 mg/ml), with the help of bath sonication or magnetic stirring, as shown in FIG. 1c. For some applications, graphene dispersed in organic solvents would be preferred to aqueous solutions, ME-LOGr also forms a stable colloidal suspension in organic polar solvent, such as N,N-dimethylformamide (DMF), demonstrated by the Tyndall effect, as shown in FIG. 7. ME-LOGr is easily dispersed both in water and DMF without amphiphilic surfactants or stabilizers, indicating the amphiphilic nature of the ME-LOGr surfaces, quite different from graphene sheets known in the art. It is known in the art that GO, while soluble in water, is not dispersed in DMF to produce a homogeneous suspension even with lengthy sonication of over 24 hours. On the other hand, most of the reduced GO can be dispersed in organic solvents, but not water. The solubility of ME-LOGr in different solvents with different Hansen solubility parameters is much greater than reduced GO. This enhanced solubility in different solvents is of great significance for various applications.

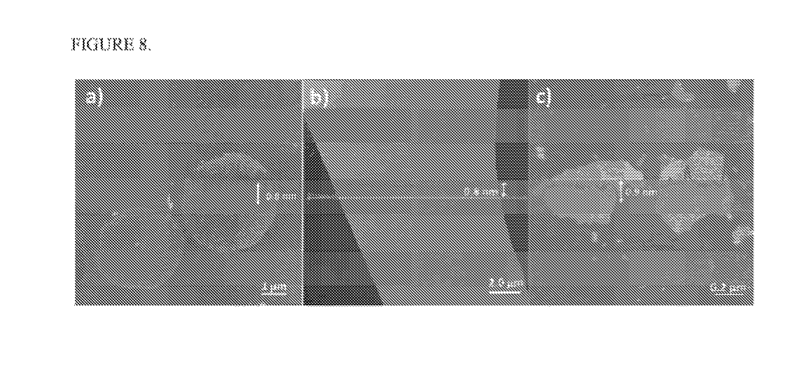

These solutions are stable, showing no precipitation for several months. The sizes of the graphene sheets dispersed by bath sonication are several microns, as shown in FIG. 8a, which is significantly larger than GO sheets prepared by Hummer's method (FIG. 8b). When the graphene powder is exfoliated by magnetic stirring, graphene sheets of even larger sizes are observed, as shown in FIG. 8b.

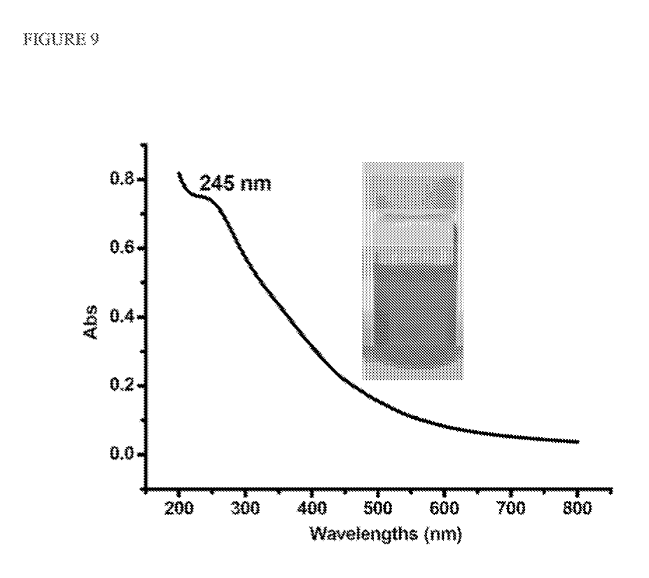

The color of ME-LOGr suspensions is grayish-black, which qualitatively suggests that we have directly obtained electrically conductive graphene sheets instead of the typically brown GO solutions (FIG. 1c, inset). A control experiment was performed by adding a small amount of KMnO₄ to the HNO₃/H₂SO₄ acid mixture. This yielded a bright yellow solution of fully oxidized GO, as shown in FIG. 9, demonstrating the importance of excluding KMnO₄ in our procedure. Additionally, unlike GO, the UV-vis-near-IR spectrum of the ME-LOGr solution displayed an absorption maximum at 267 nm and relatively uniform absorption in the visible and NIR regions (FIG. 1c), which suggests that the π-conjugation within the graphene sheets is largely retained. However, when conventional (instead of microwave) heating was used, a fully oxidized GO was obtained, demonstrating the utility of microwave irradiation.

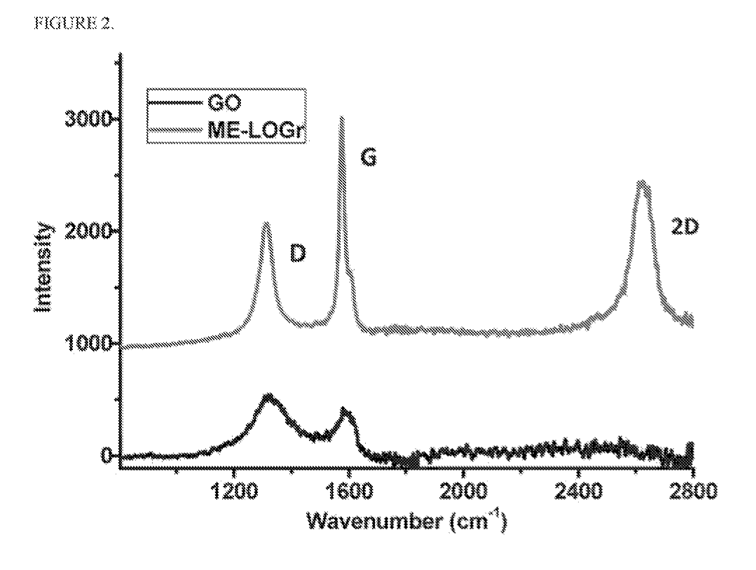

FIG. 2 shows the Raman spectra of MF-LOGr and GO films deposited on alumina membranes. The typical features of the G band, defect D band, and 2D band are shown in the Raman spectrum of ME-LOGr. The D to G band intensity ratio (I_{D}/I_{G}) is 0.45 and 1.23 for ME-LOGr and GO, respectively. Using the empirical Tuinstra-Koening relation, it is found that the size of the ordered crystallite graphitic domains is about 10 nm in ME-LOGr, while the domain size in GO is approximately 3.5 nm. The reported by I_{D}/I_{G} ratios tor reduced GO (“r-GO”) are similar to or even higher than GO, explained by the fact that the chemical reduction tends to generate a greater number of small crystalline domains rather than increasing the size of crystallite graphitic domains. Therefore, though the apparent electronic structure of the ME-LOGr sheets is similar to that of rGO, as demonstrated by its color and UV-vis spectrum, the ME-LOGr sheets have unique molecular structures that differ from, both GO and rGO.

The 2D band in GO is absent, which is consistent with what is known in the art. Additionally, it is known that reduction of GO results in only a small increase in the 2D band due to the defects in the graphitic structures. A decrease of the 2D band is also associated with the modification of pristine graphene through chemisorption and physisorption. However, for ME-LOGr the intensity of the 2D band is similar to that of the G band, demonstrating the better graphitic structures and “clean” surface of the ME-LOGr without adsorbent-induced surface modification.

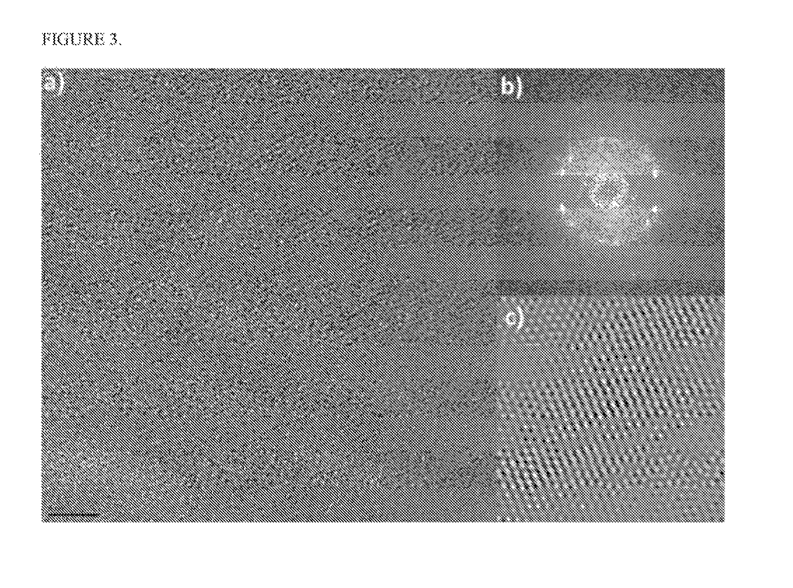

To further understand the structure of the ME-LOGr on an atomic level, low-voltage aberration-corrected high-resolution transmission electron microscopy (“HRTEM”) is used to carefully examine the structure of the ME-LOGr sheets and compare them to what is known in the art regarding GO and rGO. Both GO and rGO contain nearly perfect graphene domains ranging from 1-3 nm separated by amorphous-like regions. Nanometer sized holes are observed in both GO and rGO. It is also noted that rGO appears to be more sensitive to the electron beam than GO during TEM imaging. Similar to GO and rGO, ME-LOGr also exhibits multiple crystalline-like domains connected by amorphous regions. However, the structure of ME-LOGr is stable during imaging and no nanometer sized holes are observed, as depicted in FIG. 3, which is in agreement with the AFM data. The crystalline domains are 6-10 nm across, larger than that observed for GO and rGO, consistent with the Raman study.

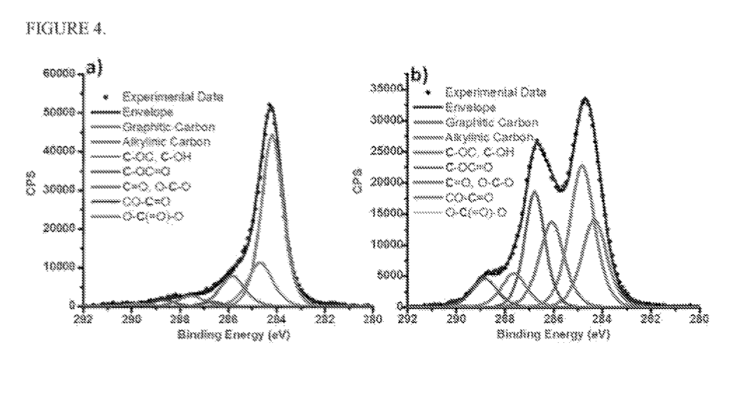

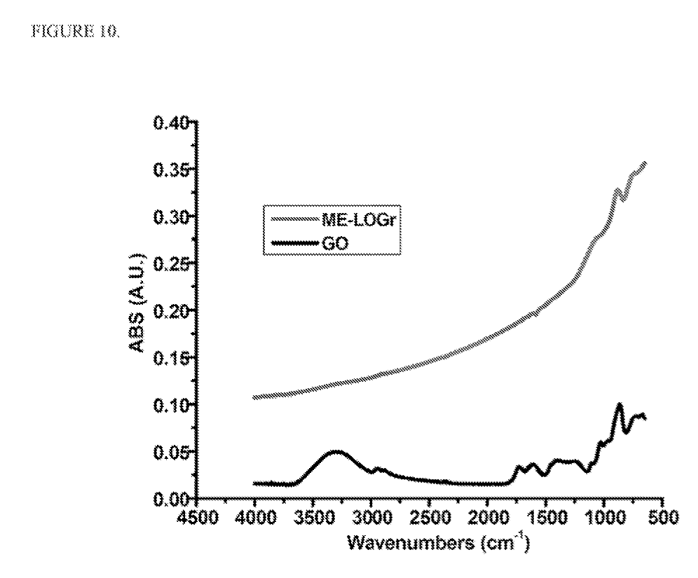

The chemical functionalities of the ME-LOGr sheets are studied by X-Ray photoelectron spectroscopy (“XPS”) and Fourier transform infrared spectroscopy (“FTIR”). The C is core-level XPS spectrum of ME-LOGr shows a main peak of oxygen-free carbon and a shoulder of oxygen-containing carbon, as shown in FIG. 4a. The oxygen-free carbon of ME-LOGr makes up 79% of the spectrum, comparable to those in reduced GO. The spectrum of GO exhibits two main peaks, depicted in FIG. 4b, which result from the lower energy oxygen-free carbon and oxygen-containing carbon signals, respectively. The oxygen-free carbon signal is 49% of the total carbon signal, which is much lower than that in ME-LOGr. Measurements by Rutherford backscattering spectrometry (“RBS”) show that ME-LOGr exhibits almost an order of magnitude lower oxygen content than that in GO films (C:O ratios of 25:1 and 3:1, respectively), consistent with the XPS study. Neither of these two techniques detect nitrogen nor sulfur in the films, suggesting that no nitration or sulfonation occurred. The XPS contribution from the oxidized carbon species in ME-LOGr is in agreement with FTIR data that identifies the majority of species as alcohol and epoxide functional groups as shown in FIG. 10. ME-LOGr contains a very small amount of carbonyl containing groups, which is in contrast to GO. This further illustrates the different oxidation mechanisms of NO₂⁺ and KMnO₄.

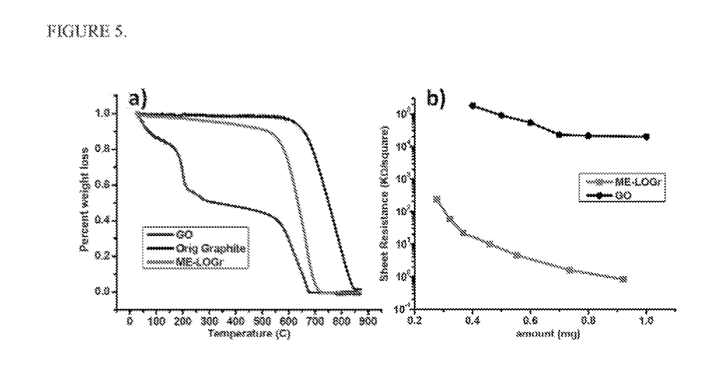

The thermal stability of ME-LOGr sheets is compared to GO and the parent graphite powder using thermal gravimetric analysis (“TGA”), as shown in FIG. 5a. Below 100° C. the major mass loss has been assigned to desorption of water molecules, even though a complete desorption of water may need higher temperatures. The high water content in GO is the result of the high concentration of oxygen-containing functionalities as well as strong hydrogen bonding interactions between water molecules and these functional groups in close proximity. Thus, the minor mass loss of ME-LOGr in this temperature range indicates that the material exhibits only a weak interaction with water, behaving similar to the parent graphite powders.

Further increasing temperatures, GO continues losing mass presumably due to pyrolysis of the labile oxygen-containing functional groups. The sharp mass loss that occurred near 200° C. is assigned to pyrolysis of hydroxyl and/or epoxide groups. The mass loss at higher temperatures (between 200-300° C.) is attributed, to carboxyl groups. So the low weight loss in these temperature ranges further suggests the low concentration of hydroxyl, epoxide and carboxyl groups in ME-LOGr sheets, which is consistent with the XPS results. The sharp mass loss above 500° C. has been ascribed to the burning of carbon in the graphene backbone. Even though the rate of moss loss for GO and ME-LOGr is similar between 300˜500° C., the complete combustion for GO happens at a lower temperature, with the highest temperature for the parent graphite powders. It is interesting to note that even though the rate of mass loss of GO and ME-LOGr was similar between 300˜500° C., the complete combustion of ME-LOGr happens at a higher temperature than GO.

Thermal annealing is widely used to reduce GO to restore conductivity. This result indicates that the ME-LOGr has better thermal stability than thermally reduced GO sheets. The evolution of carbon bonds in GO thin films is studied by monitoring XPS and infrared differential spectra as a function of annealing temperatures. Thermal annealing of GO is shown to involve the removal of the entrapped water molecules and the epoxide and hydroxyl groups by formation of H₂O, H₂, O₂ (oxygen elimination), and also CO and CO₂ (carbon elimination) thus creating defects in the form of etch holes within the graphene basal plane. The existence of a large number of holes and vacancies in rGO obtained by a combination of chemical and thermal reduction dramatically decreases the stability to the electron beam of TEM during imaging. The relative higher thermal stability of the ME-LOGr is consistent with the TEM observation that the structure of ME-LOGr is stable during imaging and ME-LOGr has less defects and holes.

Graphene films from the ME-LOGr suspensions with different thicknesses are prepared by a vacuum filtration method through an anodic fiber membrane. The electrical properties of the graphene sheets are studied by measuring the sheet resistance of the corresponding graphene films with a four-probe approach. Similar to all of the other graphene sheets dispersed in solutions, the ME-LOGr films show a percolation electronic behavior. The sheet resistance of the ME-LOGr film decreases with increasing film thickness, as shown is FIG. 5b. After reaching the percolation threshold, the sheet resistance of the ME-LOGr film is 1.0 kΩ/square. To estimate the DC conductivity of the film, a filtered ME-LOGr film was divided into two parts. One part was transferred, onto a quartz substrate for conductivity measurements and the other half was transferred onto a beryllium substrate to precisely measure the thickness of the film (see detail in supplementary materials). The sheet resistance was measured to be 0.76 kΩ/square and the thickness of the film is for 200 nm. This corresponds to a DC conductivity of 6600 S m⁻¹. Depending upon reaction conditions, the present invention provides as-synthesized graphene with conductivity between about 2800 S m⁻¹ to 10,000 S m⁻¹, and more typically between about 4,000 and about 8,000 S m⁻¹.

The relatively high conductivity was achieved on the as-prepared film which was neither chemically nor thermally reduced. This conductivity is much higher than graphene directly exfoliated in the presence of surfactants/stabilizers even though they were known to have a low density of defects. For instance, the graphene sheets dispersed in sodium dodecylbenzene sulfonate (SDBS) has a DC conductivity of 35 S m⁻¹. Recently, we reported that the DC conductivity of the graphene sheets dispersed in the presence of pyrene derivatives before thermal annealing was around 1900 S m⁻¹. The conductivity of the as-produced ME-LOGr is much more comparable to surfactant-free reduced GO sheets obtained by hydrazine reduction under basic conditions (DC conductivity of 7200 S m⁻¹). We believe that the high conductivity of the ME-LOGr film is due to the high conductivity as well as the relative cleanliness (non-functionalization) of the individual ME-LOGr sheets, which enables low inter-sheet contact resistance.

It is known that directly exfoliating graphite in certain organic solvents, such as N-methyl-pyrrolidone (NMP), can produce graphene sheets with not only a low density of defects, but also clean surfaces without any surfactants or stabilizers. However, these solvents are expensive, require special care, tend to have high boiling points, and are difficult to completely remove. Residual solvent also results in poor electronic contacts between graphene sheets and therefore lowers the overall conductivity of the resulting multisheet graphene films. It was reported that the as-produced film has a conductivity of 5 S m⁻¹. After thermal annealing at 300° C. for 2 hours, a conductivity of 5000 S m⁻¹ was achieved. With annealing in a reductive environment (Ar/H₂) at 250° C. for 2 hours, a slightly higher conductivity of 6500 S m⁻¹ was achieved.

Upon annealing a ME-LOGr film at 300° C. in Ar for 2 hours to remove some of the oxygen containing groups, the conductivity was increased: to 19,000˜25,000 S m⁻¹, significantly higher than films prepared via graphene dispersed by NMP and hydrazine reduced GO in basic conditions. Depending on conditions conductivity may be increased to between about 12,000 and about 100,000 S m⁻¹, and more typically to between about 20,000 and about 75,000 S m⁻¹ with a conductivity increase to between about 25,000 and about 50,000 S m⁻¹ being more typical.

Depending upon the conditions applied post-exfoliation, the graphene sheets of the present invention have a carbon to oxygen ratio between about 10:1 and about 50:1, and typically between about 20:1 and about 40:1. More typically, the carbon to oxygen ratio is between about 20:1 and about 35:1

Microwave methodologies are easy to scale without suffering thermal gradient effects, providing a potentially industrially important improvement over convective methods. Microwave irradiation is also exploited for other graphene research projects. For example, it has been applied, to fabricate exfoliated graphite (“EG”) from a wide range of graphite intercalation compounds (“GIC”), simultaneous exfoliation and reduction of GO, and simultaneous intercalation and exfoliation of graphite powder. However, this is the first invention where large, highly conductive single layer graphene sheets are directly and rapidly produced with high yield.

### Monodispersed Low-oxygen Containing Graphene Nanosheets

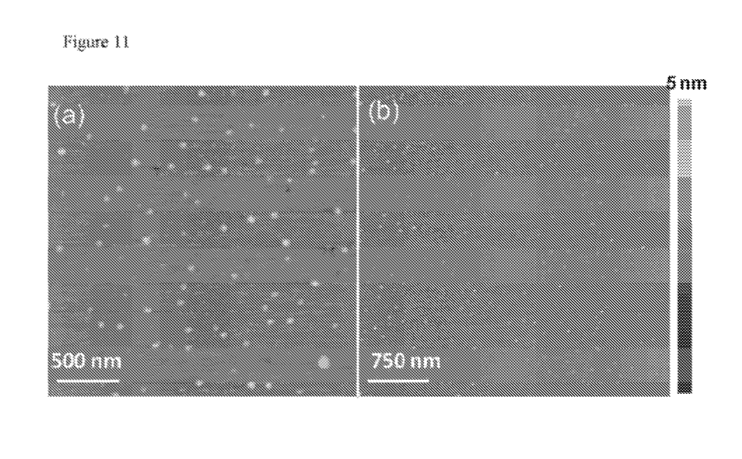

By rising a similar method described for large microwave enabled low oxygen containing graphene sheets (ME-LOGr), by simply extending the duration of microwave irradiation to 1˜3 minutes, or by changing the H₂SO₄/HNO₃ ratios to increase the concentration of nitronium ions, monodispersed graphene sheets with controlled sizes from 10 to 100 nm, which are referred to ME-LOGr nanosheets, are directly obtained. FIG. 11 shows atomic force microscope images the ME-LOGr nanosheets of two different sizes. The ME-LOGr nanosheets in FIG. 11a are directly fabricated via extending microwave irradiation time to 2 minutes (120 seconds) with the same H₂SO₄/HNO₃ ratio of 1.1 as that applied during fabrication of the larger ME-LOGr sheets described earlier. The graphene nanosheets are uniform in both lateral dimensions and height. The nanosheets have a lateral size of 64±8 nm. By changing the H₂SO₄/HNO₃ ratio to 4:1 to increase the nitronium ion concentration during reaction, graphene nanosheets with an average size of 12±6 nm are directly obtained with 30-seconds microwave irradiation, as shown in FIG. 11b. These nanosheets show a similar or even much narrower size distribution relative to those obtained from post-separation approaches.

From height measurements, all of these sheets are single layer graphene with an average thickness of 0.75±0.23 nm, similar to the larger ME-LOGr sheets. The concentration of the ME-LOGr nanosheets can be as high as 4 mg/ml in aqueous solutions without the need of surfactants for stabilization. All nanosheet solutions are dark grey, in contrast to the yellow-brown color of GO nanosheet solutions, indicating that graphene nanosheets instead of GO nanosheets are directly obtained without a post-reduction process.

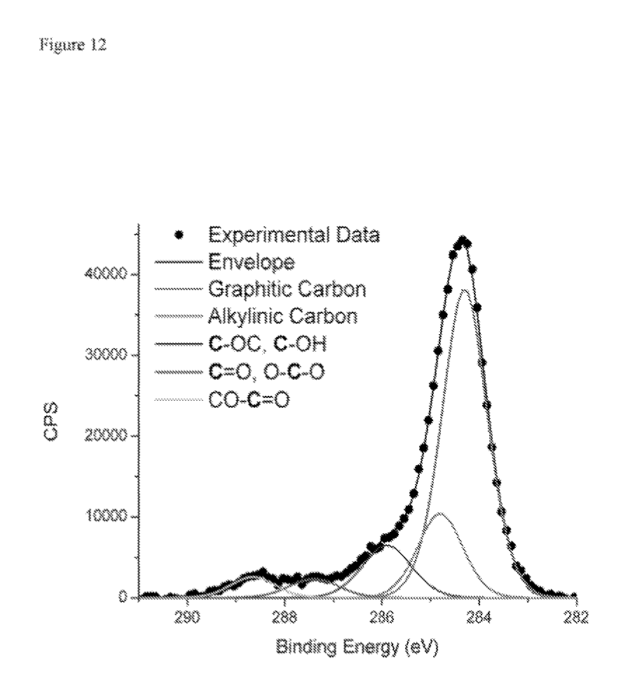

The ME-LOGr nanosheets also have much lower concentrations of oxygen and higher oxygen-free carbon relative to graphene oxide, as measured by XPS, as shows in FIG. 12. The amount of oxygen-free carbon in the ME-LOGr nanosheets is as high as 80% of the total carbon and higher, which is almost the same as the larger-sized ME-LOGr sheets. This result further demonstrates that graphene nanosheets are directly produced.

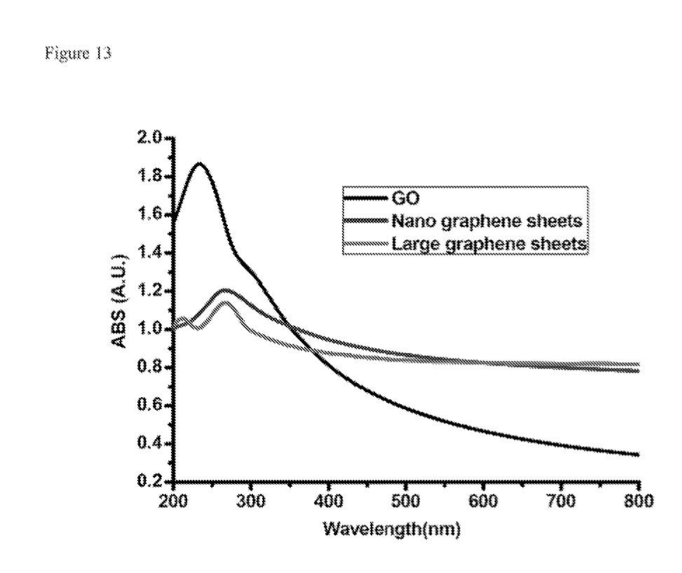

The nanosheets show strong visible and NIR absorption, similar to the large graphene sheets, as shown in FIG. 13. Their plasmon band in the UV region is centered at −264 nm, largely red shifted compared to GO nanosheets (−233 nm), indicating that the ME-LOGr nanosheets are also in their reduced states instead of heavily oxidized GO states. Compared to the large ME-LOGr sheets (267 nm), it is slightly blue shifted, possibly due to the existence of more edges stemming from their smaller size. The non-photoluminescent feature of ME-LOGr nanosheets ensures higher photothermal efficiency than GO and rGO nanosheets. The higher NIR absorption, higher optical-heat-conversion, and the larger intact graphene domains are critical factors for novel uses that require highly efficient ablation of viruses, bacteria, and/or malfunctioning cells, including cancer cells and drug delivery systems with high drug loading efficiency.

Accordingly, these simple, scalable, highly efficient and low-cost approaches to directly produce highly conductive and amphiphilic graphene sheets and graphene nanosheets open a broad range of real-world applications with low-cost solution processing techniques.

### EXAMPLES

Synthetic graphite powder (˜20 μm) used in the following examples was purchased, from Sigma Aldrich and used as received. ACS grade concentrated sulfuric acid (98% H₂SO₄) and concentrated nitric acid (70% HNO₃) were purchased from Pharmco-AAPER and used as received. All solutions were prepared using deionized water (18.2 MΩ) (Nanopure water, Barnstead), which was also used to rinse and clean the samples.

### Example 1

### Using Microwave Heating to Produce Lightly Oxidized Graphene Sheets (ME-LOGr)

20 mg of synthetic graphite powder was added to a mixture of sulfuric acid and nitric acid, (ratio of 1:1 with a total volume of 10 mL) in a round bottom flask. The mixture was then swirled and mixed, and then placed into a CEM Discover microwave reactor chamber. The flask was connected to a reflux condenser, which passes through the roof of the microwave oven via a port, and subjected to 30 seconds of 300 watt microwave irradiation. The graphene sheets were formed as a suspension in the aqueous phase above the solid residual of unreacted graphite. The whole content was then filtered through an anodisc alumina filter membrane with 0.2 μm pore size, and washed with 600 mL of deionized water. The filtrand was then re-dispersed into water with a 30 minute bath sonication. The obtained grey dispersion was then centrifuged at 4000 r.p.m. for 20 minutes to remove the small amount of un-exfoliated graphite using a Beekman J2-21 centrifuge. The supernatant was then carefully decanted and all visible agglomerates were avoided, forming the stock graphene solution. This solution is stable for months without significant precipitation. The yield of graphene sheets was estimated to be 50% by weight. The resulting solution was directly used to prepare graphene films with a vacuum filtration method.

### Example 2

### Control Experiment

A control experiment was performed by adding a small amount (0.65 g) of KMnO₄ into the HNO₃/H₂SO₄ mixture of Example 1 prior to the microwave irradiation. The solution was then neutralized, using 4M NaOH, and extensive dialysis was performed to completely remove the produced salt and ions.

### Example 3

### Synthesis of GO

GO was synthesized using the modified Hummer method from the same graphite powder mentioned above. Accordingly, 0.5 g of graphite, 0.5 g of NaNO₃ and 23 mL of H₂SO₄ were stirred and mixed until homogenized in an ice bath. Then 3 g of KMnO₄ was gradually added into the reaction over 1 hour while stirring. The reaction temperature was maintained at about 35° C. in a wafer bath. After 1 hour, 40 mL of water was then added into this brownish thick, paste. The solution was stirred for another 30 minutes after the temperature was stabilized at 95° C. 100 ml, more of deionized (“DI”) water was then added to the solution, followed, by 3 ml, of 35% H₂O₂ while the temperature of the solution was still maintained at around 95° C.

Upon the addition, of H₂O₂, the color of the solution turned from dark brown to yellow. Finally, this warm and yellow-ish solution was filtered with a 0.2 μm polycarbonate filter and extensively washed with 1 L of DI water to remove all traces of acid and metal. Because of the paste-like characteristic of the final products, one-fifth of it was taken at a time for filtration and cleaning, which usually takes 6 hours to overnight to remove away all the ions and acids. The following day this filter cake was then re-dissolved into DI-water with mild sonication, forming GO stock solutions.

### Example 4

### Characterization

### a) Atomic Force Microscopy (AFM)

The morphology of the ME-LOGr and GO samples were studied using a Nanoscope IIIa multimode SPM (Digital Instrument) with a J scanner operated in tapping mode. AFM samples were prepared by slowly dip-coating freshly cleaved mica into the graphene solution, and slowly removing the mica from the solution at a pull-up rate of 1 mm/min. The mica surface was rinsed with 20 μL of DI water and dried in a fume hood for 20-30 minutes. During imaging, a 125 μm long rectangular silicon cantilever/tip assembly (Model: MPP-12100. Veeco) was used with a resonance frequency between 127-170 kHz, a spring constant of approximately 5 N/m, and a tip radius of less than 10 nm. The applied frequency was set on the lower side of the resonance frequency and the scan rate was ˜1.0 Hz. Height differences were obtained from section analysis of the topographic images.

### b) Raman Spectroscopy

Raman spectroscopy was used extensively to characterize graphene materials because it is a direct and non-destructive method that gives very useful information about the quality of the graphene, Raman spectra from films deposited on alumina membranes using Buchner filtration were collected in a Kaiser Optical Systems Raman Microprobe with a 785 nm solid state diode laser. Spectra were acquired using a 30 second exposure time and four accumulations.

### c) TEM

The ME-LOGr sheets were characterized using a JFOL 2010F OF FEG transmission election microscope (TEM) at an accelerating voltage of 80 kV. The TEM samples were prepared by drying a droplet of the graphene suspension on a lacey carbon grid.

### d) X-Ray Photoelectron Spectroscopy (XPS) and Rutherford Backscattering Spectroscopy (RBS)

XPS characterization was -performed after depositing the ME-LOGr or GO suspension onto a gold film (a 100 nm gold layer was sputter-coated on silicon with a 10 nm Ti adhesion layer). The thickness of the ME-LOGr/GO film on the gold substrates was roughly 30 nm. XPS was obtained using a Thermo Scientific K-Alpha system with a monochromated Al Kα x-ray source (hv=1486:7 eV) and a hemispherical analyzer. Calibration was performed in-situ with an ion-sputtered Au foil (Sigma Aldrich, 99.999% pure) with the Au 4f 7/2 peak centered at a binding energy of 83.9 eV with a FWHM of 0.9 eV. Prior to sputtering, adventitious carbon (aliphatic) on the same foil possessed a binding energy of 284.7 eV and a FWHM of 1.2 eV, in agreement with literature values. To compensate for charging in the GO sample, a rigid energy shift (small, of order 0.1-0.2 eV) was applied to samples so that the underlying An substrate matched the values of the Au foil; no such correction was required with the ME-LOGr film.

The peak-fitting routine employed here was found to reproducibly provide good data fits for various forms of carbon (GO, ME-LOGr, and CNTs). A Shirley background removal was applied prior to fitting. Individual peak shapes were fit with a symmetric Gaussian-Laurentz hybrid function. The true FWHM of deconvoluted peaks are a combination of intrinsic photoelectron core-hole lifetimes and instrumental broadening. To a first approximation we assume that the FWHM of the various carbon species present in the films will lie somewhere within the range of FWHM exhibited by adventitious sp³ Cls and Au 4f 7/2. The values for FWHM were allowed to float within the range of 0.9-1.2 eV. Relative binding energies for the different carbon species were obtained from the work of Briggs and Beamson and were related to the absolute energy value for adventitious carbon as noted above. The graphitic carbon peak was assigned a fixed value of 284.2 per the literature value of HOPG. Finally, a least square fit routine was performed to determine the height and area for each peak.

Further analysis of the XPS spectra shed light on the specific bonding present in each material. The oxygen free carbon was mainly derived from the C 1s peak of aromatic rings (284.2 eV), and that of the aliphatic rings and/or linear alkylinic carbon chains (284.7 eV). The C content from aromatic rings in ME-LOGr is apparently much greater than that in GO.

Rutherford Back Scattering (RBS) was performed using a 2 MeV He2+ on beam generated in a tandem accelerator with an ion current of 2-3 nA. Spectra were collected in the back angle geometry and simulations were performed using the SIMNRA program. Samples consisted of thick (several tens of μm) films of GO and ME-LOGr deposited onto HOPG substrates,

### e) TGA

TGA was performed with a nitrogen flow (20 ml/min) using a Perkin Elmer Thermogravimetric Analyzer Pyris 1 TGA on sample sizes of about 2-3 mg, and the mass was recorded as a function of temperature. The samples in the TGA furnace were heated from room temperature to 1000° C. at a rate of 5° C./min.

### f) Optical and Electrical Properties of Dispersed Graphene Sheets.

UV-vis-NIR absorption spectroscopy was used to characterize the electronic states of the exfoliated, graphene sheets. All spectra were obtained using a Cary 500 visible-near-infrared (UV-vis-NIR) spectrophotometer in double-beam mode. Graphene films of different thicknesses were prepared by Buchner filtration of the corresponding suspensions onto Anodisc 47 inorganic membranes with 200 nm pores (Whatman Ltd.). After filtration, the thin films were dried in air for 15-20 min. The sheet resistance of the films was determined by a 302 manual four point resistivity probe (Lucas Laboratories).

The foregoing examples and description should be taken as illustrating, rather than limiting, the present invention as defined by the claims. As will be readily appreciated, numerous variations and combinations of the features set forth above can be utilized without departing from the present invention as set forth in the claims. Such variations are not regarded as a departure from the spirit and scope of the invention, and all such variations are intended to be included within the scope of the following claims.

All references cited herein are incorporated by reference herein in their entireties.

1. A method for making Microwave Enabled Low Oxygen Graphene Sheets (“ME-LOGr”) comprising:
mixing graphite powder with a solution of concentrated sulfuric acid and nitric acid; and
subjecting the resultant mixture to microware irradiation until a finely dispersed suspension of ME-LOGr sheets is formed in said solution.

2. The method of claim 1, wherein the amounts of graphite, sulfuric acid and nitric acid are selected to provide a g/mole ratio of graphite to nitronium ions between about 100 to about 0.3 g/mole ratio.

3. The method of claim 2, wherein the amounts of graphite, sulfuric acid and nitric acid are selected to provide a g/mole ratio of graphite to nitronium ions between about 50 to about 0.5 g/mole.

4. The method of claim 2, wherein the amounts of graphite, sulfuric acid and nitric acid are selected to provide a g/mole ratio of graphite to nitronium ions between about 50 g/mole to about 30 g/mole.

5. The method of claim 4, wherein the amounts of graphite, sulfuric acid and nitric acid are selected to provide a g/mole ratio of graphite to nitronium ions between about 45 and about 35 g/mole.

6. The method of claim 2, wherein the amounts of graphite, sulfuric acid and nitric acid are selected to provide a g/mole ratio of graphite to nitronium ions between about 0.3 to about 25 g/mole.

7. The method of claim 6, wherein the amounts of graphite, sulfuric acid and nitric acid are selected to provide a g/mole ratio of graphite to nitronium ions between about 0.5 and about 10 g/mole.

8. A ME-LOGr product produced according to the method of claim 1.

9. Graphene sheets exfoliated by oxidation from graphite, having a single sheet average lateral size between about 3 nanometers to about 100 nanometers.

10. The graphene sheets of claim 9, having a single sheet average lateral size less than about 50 nanometers.

11. Graphene sheets exfoliated by oxidation having a single sheet average lateral size between about 1.0 μm and about 100 μm.

12. The graphene sheets of claim 11, having a single sheet average lateral size between about 2.0 μm and about 30 μm.

13. Graphene sheets exfoliated from graphite, having a conductivity between about 12,000 and about 100,000 S m⁻¹.

14. The graphene sheets of claim 13, having a conductivity between about 20,000 and about 75,000 S m⁻¹.

15. The graphene sheets of claim 14, having a conductivity between about 25,000 and about 50,000 S m⁻¹.

16. Graphene sheets exfoliated from graphite, having a conductivity as synthesized between about 2,000 and about 10,000 S m⁻¹.

17. The graphene sheets of claim 16, having a conductivity between about 4,000 and about 8,000 S m⁻¹.

18. Graphene sheets exfoliated by oxidation from graphite, having a carbon to oxygen ratio between about 10:1 and about 50:1.

19. The graphene sheets of claim 18, having a carbon to oxygen ratio between about 20:1 and about 40:1.

20. The graphene sheets of claim 19, having a carbon to oxygen ratio between about 20:1 and about 35:1
